(19) United States
(12) Patent Application Publication
(10) Pub. No.: US 2014/0248963 A1
(43) Pub. Date: Sep. 4, 2014

(54) METHOD, SYSTEM, SERVER AND COMPUTER SOFTWARE FOR PREDICTION GAME

(71) Applicant: Rutger Joan Bart Tulleken, Bussum (NL)

(72) Inventor: Rutger Joan Bart Tulleken, Bussum (NL)

(21) Appl. No.: 14/349,689

(22) PCT Filed: Oct. 5, 2012
(86) PCT No.: PCT/EP2012/069779

§ 371 Date: Apr. 4, 2014

Related U.S. Application Data
(60) Provisional application No. 61/544,191, filed on Oct. 6, 2011.

(51) Int. Cl. A63F 13/30

(52) U.S. Cl. CPC A63F 13/12
USPC 463/42

(57) ABSTRACT

In a prediction game method, system en server, data are transmitted and received through a network between a server and a user terminal. Computer software is provided to store a plurality of event data items and corresponding status data items, indicating whether the corresponding event has taken place or not, each data item associated with an event. A plurality of event data items for future events are transmitted to a user identified by a user identification. At least one choice data item transmitted by the user is received, each choice data item relating to a corresponding event data item, and indicating whether the user predicts the future event indicated by the corresponding event data item to take place or not. Received choice data item are stored in association with the corresponding event data item and the user identification. When an event becomes a past event, the corresponding status data item is updated. Then, for each user, the stored choice data items are compared with the corresponding status data items of past events. If the stored choice data item corresponds to the status data item, a count associated with the user identification is incremented. The count is stored in association with the user identification, and the count is transmitted to the user.

### FIELD OF THE INVENTION

The invention relates to the field of computer-implemented prediction games, and more specifically to a method, system, server, user terminal and computer software configured for use in a computer-implemented prediction game.

### BACKGROUND OF THE INVENTION

Prediction games invite participants to predict or guess a possible outcome of a future event, where the aim of the game is to correctly predict as many as possible future events. The correctness of the prediction follows after the event in question has taken place. Between different participants, a ranking may be established depending from the number of correctly predicted events. This in turn will stimulate the participation in the game.

Prediction games are generally operated online and may or may not have free access for users to play. Points or (cash) prizes are awarded to players who most accurately predict the outcome of an event. In some variants of the prediction game, the awarded points may be converted into cash prizes, while in other variants a cash prize or other prize may be paid or transferred to a participant only after having reached a predetermined result.

US 2009/0054127 discloses an apparatus and method for playing a multi-player future event outcome prediction game involving the prediction or forecasting or guessing of the actual outcomes of a series of pre-defined sequentially occurring future events. Players participating in the prediction game aim to predict correctly, progressively, sequentially and continuously the actual outcome of the entire set of predefined future events included in a game unit.

Although some people will enjoy playing a prediction game in which the outcome of a future event is to be predicted progressively, sequentially and continuously, for a majority of people this will demand too much of their knowledge, time and concentration. Accordingly, the number of participants will remain relatively low, and participants will not regularly play the game for lack of time. Additionally, the game involves complex count of results, thus making it difficult to devise participant strategies, and not stimulating participation.

Thus, a technical problem can be formulated as how to provide a prediction game mechanism which will enable a participant to consume little time, making easy decisions, and which is very easy to play, allowing a simple and powerful user interface and interaction.

### SUMMARY OF THE INVENTION

It would be desirable to provide a computer-implemented prediction game which can be played at least once in a predetermined time interval, such as a day, in a simple way. It would also be desirable to provide a computer-implemented prediction game providing a strong incentive for a user to participate every predetermined time interval, such as every day. It would further be desirable to provide a computer-implemented prediction game which is easy to understand, provides easy interaction in a man-machine interface and can be configured to appeal to a large part of society.

To better address one or more of these concerns, in a first aspect of the invention a method for receiving and transmitting data between a server and a user terminal, through a network in a prediction game, is provided. The method comprises the steps to:

store at the server a plurality of event data items and corresponding status data items each associated with an event, wherein the status data item indicates whether the corresponding event has taken place or not, and is unavailable when the event is a future event, and is available when the event is a past event;

transmit from the server to the user terminal at least one event data item for a future event to a user identified by a user identification;

receive at the server from the user terminal at least one choice data item transmitted by the user identified by the user identification, each choice data item relating to a corresponding event data item, and indicating whether the user predicts the future event indicated by the corresponding event data item to take place or not;

store at the server each received choice data item in association with the corresponding event data item and the user identification;

update, for each past event, the corresponding status data item;

compare at the server, for each user identification, the stored choice data items with the corresponding status data items of past events and, if the stored choice data item corresponds to the status data item, increment a count associated with the user identification;

store at the server the count in association with the user identification; and

transmit the count from the server to the user terminal.

In an embodiment of the method, the step to transmit at least one event data item comprises transmitting a plurality of event data items. The user at his/her user terminal is thus confronted with a number of future events to be predicted to take place or not.

In an embodiment of the method, the step to receive at least one choice data item comprises receiving a number of choice data items which is lower than the number of event data items transmitted. The user at his/her user terminal selects one or more future events from the total number of future events to predict whether or not these future events take place or not. The user does not need to make a prediction for all future events of which the event data items have been transmitted to the user terminal, and thus can select the future events he/she feels more comfortable about than others.

In a second aspect of the invention, a prediction game system is provided, the prediction game system comprising a server, a user terminal, and a network configured for receiving and transmitting data between the server and the user terminal,

the system comprising computer software on a computer readable medium, the computer software comprising computer instructions configured to enable the system to:

store at the server a plurality of event data items and corresponding status data items each associated with an event, wherein the status data item indicates whether the corresponding event has taken place or not, and is unavailable when the event is a future event, and is available when the event is a past event;

transmit from the server to the user terminal at least one event data item for a future event to a user identified by a user identification;

receive at the server from the user terminal at least one choice data item transmitted by the user identified by the user identification, each choice data item relating to a corresponding event data item, and indicating whether the user predicts the future event indicated by the corresponding event data item to take place or not;

store at the server each received choice data item in association with the corresponding event data item and the user identification;

update, for each past event, the corresponding status data item;

compare at the server, for each user identification, the stored choice data items with the corresponding status data items of past events and, if the stored choice data item corresponds to the status data item, increment a count associated with the user identification;

store at the server the count in association with the user identification; and

transmit the count from the server to the user terminal.

In a third aspect of the invention, a prediction game server is provided, the prediction game server being configured for transmitting and receiving data to and from a user terminal through a network, the server comprising computer software on a computer readable medium, the computer software comprising computer instructions configured to enable the server to:

store a plurality of event data items and corresponding status data items each associated with an event, wherein the status data item indicates whether the corresponding event has taken place or not, and is unavailable when the event is a future event, and is available when the event is a past event;

transmit to the user terminal at least one event data item for a future event to a user identified by a user identification;

receive from the user terminal at least one choice data item transmitted by the user identified by the user identification, each choice data item relating to a corresponding event data item, and indicating whether the user predicts the future event indicated by the corresponding event data item to take place or not;

store each received choice data item in association with the corresponding event data item and the user identification;

update, for each past event, the corresponding status data item;

compare, for each user identification, the stored choice data items with the corresponding status data items of past events and, if the stored choice data item corresponds to the status data item, increment a count associated with the user identification;

store the count in association with the user identification; and

transmit the count to the user terminal.

In a fourth aspect of the invention, computer software is provided comprising computer instructions configured to enable a processor to carry out the method of the present invention.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 depicts a schematic diagram of an embodiment of a prediction game system according to the present invention.

FIG. 2 depicts a schematic diagram of an embodiment of a user terminal configured for use in a prediction game system according to the present invention.

FIG. 3 depicts a schematic diagram of an embodiment of a server configured for use in a prediction game system according to the present invention.

FIG. 4 depicts an embodiment of a data structure for use in a prediction game system, server and method according to the present invention.

FIG. 5 depicts a flow diagram illustrating an embodiment of the method according to the present invention.

FIG. 6 depicts a part of a display showing event regions representing events.

FIG. 7 depicts a part of a display showing event regions and a count/level region.

### DETAILED DESCRIPTION OF EMBODIMENTS

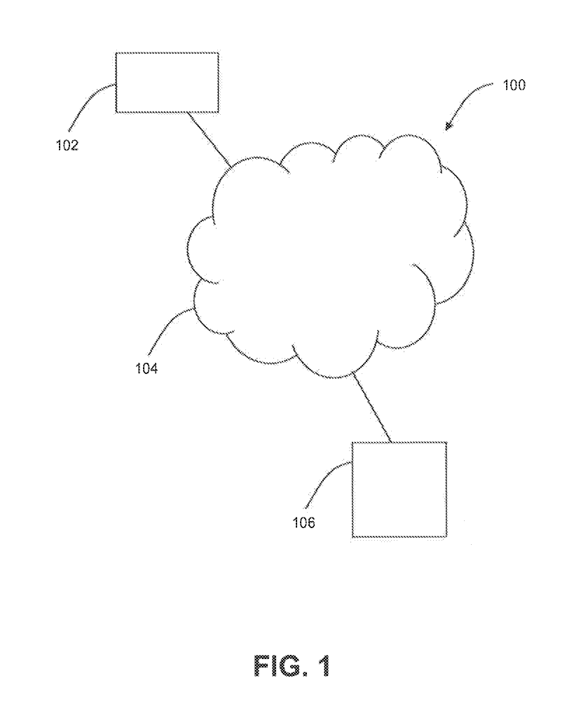

FIG. 1 schematically shows an embodiment of a prediction game system 100. The prediction game system 100 comprises a prediction game server 102 connected through a network 104 to a user terminal 106. A connection between the server 102 and the network 104, and/or a connection between the user terminal 106 and the network 104 may be wired or wirelessly. The server 102 may be an Internet server or any other type of server hosting prediction game software and communication software. The network 104 may comprise any data communication network such as the Internet and/or a telecommunication network providing data communication services. The user terminal 106 may comprise a desktop computer or a personal computer, a television set, a portable device such as a laptop computer, a telephone comprising a display, a smartphone, a Personal Digital Assistant, PDA, and the like. The user terminal 106 has digital communication capabilities. The user terminal 106 may comprise communication software, such as browser software, for communication with the server 102.

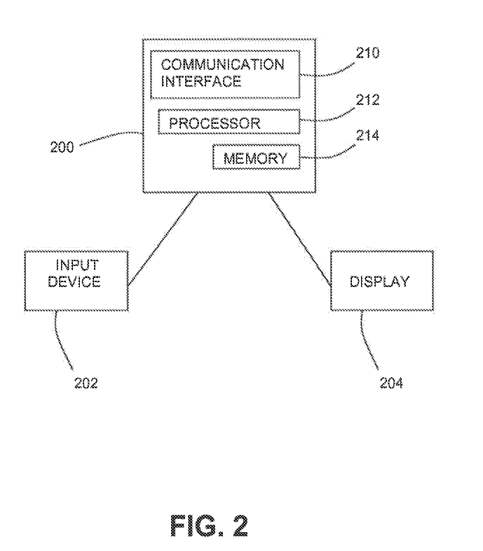

FIG. 2 schematically shows a user terminal 200 having a user input device 202 for providing input to the server 102, and a display 204 for outputting visual information, received from the server 102, to a user, who may also be referred to as a participant in a prediction game. As a user input device 202, the user terminal 200 may comprise a keyboard and/or a mouse or other pointing device allowing to indicate a particular region on the display 204, e.g. by a cursor. Alternatively, the user terminal 200 may comprise a touchscreen device having a touch-sensitive display 204, where a user's finger or other body part, or an object such as a pen or pencil may be used to touch the display 204 in a particular region for providing a user input at the user terminal 200.

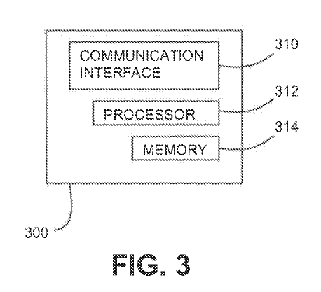

The user terminal 200 comprises a communication interface 210 comprising hardware and software configured to allow the user terminal 200 to communicate with the server 102 (FIG. 1) or 300 (FIG. 3) through the network 104 (FIG. 1). The user terminal 200 further comprises at least one processor 212 configured to process input data or data items received from the server 102, to process output data or data items to be transmitted to the server 102, to process input data received from the user input device 202 and/or to process output data to the display 204, amongst other tasks. The user terminal 200 further comprises at least one memory 214 which may comprise RAM and/or ROM storage for data to operate the user terminal 200, and may be configured to store data input to, and output from the user terminal 200 temporarily or permanently.

FIG. 3 schematically shows a server 300 comprising a communication interface 310, processor 312 and memory 314. The communication interface 310 comprises hardware and software configured to allow the server 300 to communicate with the user terminal 200 (FIG. 2) through the network 104 (FIG. 1). The server 300 further comprises a processor 312 or a plurality of processors configured to process input data or data items received from the user terminal 200, and/or to process output data or data items to be transmitted to the user terminal 200, amongst other tasks. The server 300 further comprises a memory 314 or a plurality of memories which may comprise RAM and/or ROM storage for data to operate the server 300, and to store data input to, and output from the server 300 temporarily or permanently.

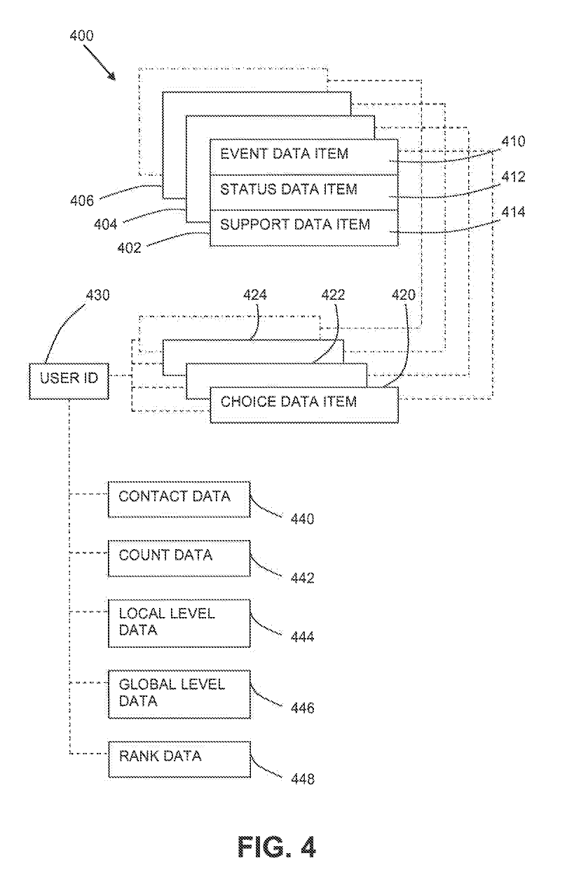

FIG. 4 illustrates a data structure 400 of different data items in one or more memories of the prediction game system 100. The data items may be stored in server memory 314, or at any other location where they may be stored and retrieved through server communication interface 310 for use in the system 100. In FIG. 4, associations or relations between data or other data items are indicated with dashed lines.

The data structure comprises a plurality of event-related data sets 402, 404, 406, . . . of a variable number, as indicated by a dash-dotted (part of a) box. Each event-related data set 402, 404, 406 relates to an event in the physical or virtual world that can be predicted (when it is a future event) and observed (when it is a past event) by a person (user, participant) to take place or not. Each event-related data set 402, 404, 406 comprises at least an event data item 410, a status data item 412, and a support data item 414. The event data item 410, status data item 412 and support data item 414 are associated with one another within one event-related data set of the plurality of event-related data sets 402, 404, 406, . . . . In some embodiments, an event data item 410 comprises text data describing a event. Examples of such event data items 410 are texts “Soccer team wins competition tomorrow” (where a specific soccer team is mentioned), “Smartphone manufacturer launches new operating system” (where the smartphone manufacturer is explicitly named), “Celebrity reveals truth about relationship” (where the celebrity is explicitly mentioned), et cetera. In some embodiments, a status data item 412 comprises data indicating whether the event is true or false, if the event is a past event, i.e. the event has taken place, and the outcome is known. Here, the status data item 412 is available. However, when the event has not taken place yet, and the outcome is not known yet, the event is a future event, and the status data item 412 is unavailable. In some embodiments, the support data item 414 comprises data representing a still picture, a moving picture, a graphical item, characters, text, or any other data supporting the event data item 410, such as a category descriptor indicating a category of the event (e.g. “society”, “technology”, “entertainment”, etc.).

The data structure further comprises a user identification, user ID, 430 which may have associated with it (as indicated by dashed lines) contact data 440, count data 442, local level data 444, global level data 446 and rank data 448. The contact data 440 comprises data relating to a name, address, city, zip code, e-mail address, etc. of a user. The count data 442 indicate a count of past events predicted correctly by the user identified by the user ID 430 over a predetermined period of time. The local level data 444 may indicate a user level, obtained by the user through past events predicted correctly, for ranking different local users (such a users in a specific geographic region, such as a country) relative to one another. The global level data 446 may indicate a user level, obtained by past events predicted correctly, for ranking users from all distinguished geographic regions relative to one another. The rank data 448 may indicate a specific name corresponding to the value of the count, the local level or the global level, where names e.g. are chosen following a hierarchy. For example, twelve ranks may run from rank 0 (lowest) to rank 11 (highest), respectively indicated by: farmer (rank 0), hunter (rank 1), explorer (rank 2), merchant (rank 3), gentleman (rank 4), knight (rank 5), count (rank 6), prince (rank 7), king (rank 8), emperor (rank 9), genius (rank 10) and wizard (rank 11). As another example, twenty-three ranks may run from rank 0 (lowest) to rank 22 (highest), respectively indicated by: beginner (rank 0), baby (rank 1), toddler (rank 2), scholar (ranks 3, 4, 5, 6), student (ranks 7, 8, 9, 10), graduate (rank 11), employee (rank 12), manager (rank 13), boss (rank 14), teacher (rank 15), researcher (rank 16), scientist (rank 17), professor (rank 18), mastermind (rank 19), genius (rank 20), magician (rank 21) and wizard (rank 22).

The user ID 430 further has associated with it (as indicated by dashed lines) a plurality of choice data items 420, 422, 424, . . . of a variable number as indicated by a dash-dotted (part of a) box. Each one of the choice data items 420, 422, 424, . . . indicates an event status predicted by the user having user ID 430, the event status being the status of a corresponding event associated with (as indicated with dashed lines) one of the event-related data sets 402, 404, 406, . . . .

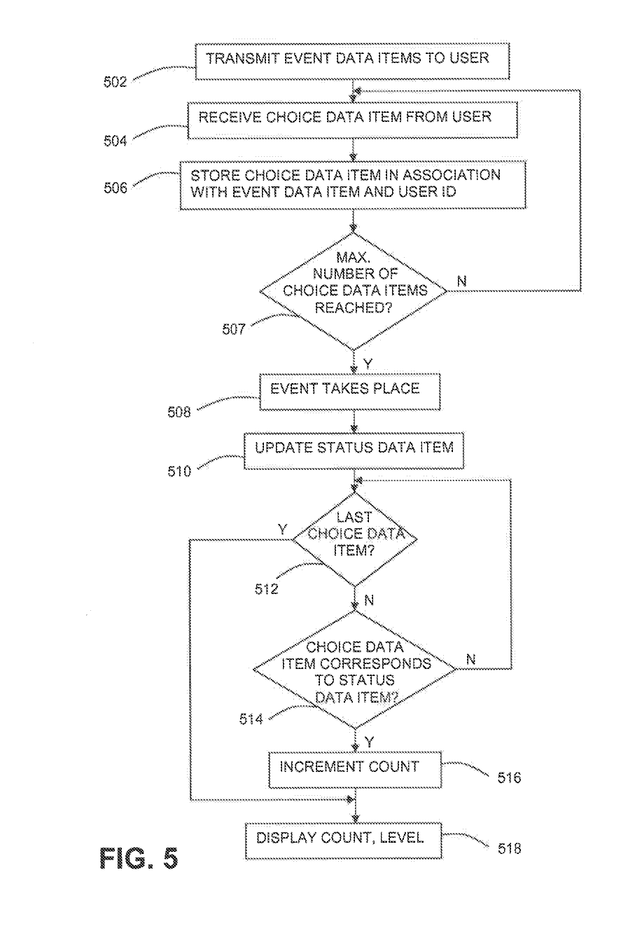

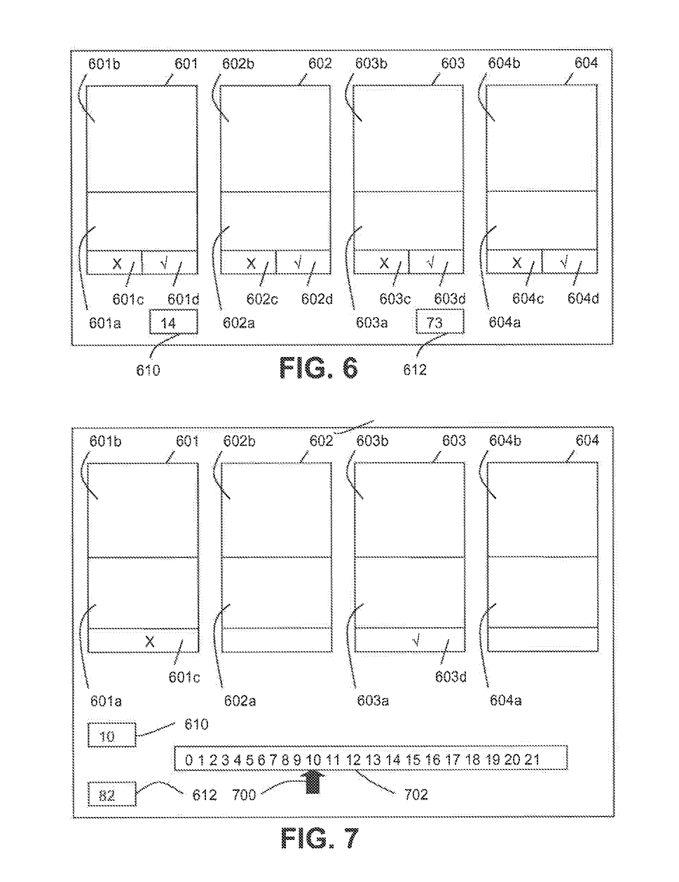

In the system as explained above with reference to FIGS. 1-4, a user (participant in a prediction game) may register, and may thereby identify himself/herself by inputting contact data 440. The system will then assign a user ID 430 to the user. Next, the system may operate as follows, as illustrated in the flow diagram of FIG. 5 and the display views of FIGS. 6 and 7.

The server 102, 300 (FIGS. 1, 3) runs prediction game computer software provided on a computer readable medium such as a storage medium. The computer software comprises computer instructions configured to cause the server, when the software is loaded in one or more processors of the server, to perform operations as described in detail below, in conjunction with a user terminal 106, 200 (FIGS. 1, 2) connected to the server 102, 300 through a network 104 (FIG. 1).

At the server 102, 300, or under control of the server 102, 300, a plurality of event data items 410 (FIG. 4), corresponding status data items 412 (FIG. 4), and possibly corresponding support data items 414 (FIG. 4) each associated with a particular event are stored as event-related data sets 402, 404, 406, . . . .

When a user has identified himself/herself at the server 102, 300, the server 102, 300 may transmit a number of event data items 410 to the corresponding user terminal 106, 200 (FIG. 5, 502). The event data items 410 may be supplemented with a same number of associated support data items 414. In some embodiments, said number is greater than one.

Next, as shown in FIG. 6, at the display 204 (FIG. 2) of the user terminal 200, a number of (in the embodiment shown, four) event regions 601, 602, 603, 604 are shown to the user. An event is described in the event region, and may refer to any subject which is susceptible to prediction, i.e. which either may, or may not occur in the future, depending on circumstances. Such subjects include (the result of) a sports event, a social event, a political event, a financial event, or any other event.

Each event region 601, 602, 603, 604 comprises an event description region 601a, 602a, 603a, 604a, respectively, configured to display an event text in accordance with one of the event data items 410 received. Each event region 601, 602, 603, 604 may further comprise a support region 601b, 602b, 603b, 604b, respectively, configured to display support information in accordance with one of the support data items 414 received, where the event data item 410 and the support data item 414 are associated with the same future event for a particular one of the regions 601, 602, 603, 604. In the embodiment of FIG. 6, four event data items 410 and four associated support data items 414 are transmitted to the user terminal 200.

Each event region 601, 602, 603, 604 further comprises a first reply region 601c, 602c, 603c, 604c, respectively, and a second reply region 601d, 602d, 603d, 604d, respectively. Each first reply region 601c, 602c, 603c, 604c is visually distinguished from the adjacent second reply region 601d, 602d, 603d, 604d, respectively. As an example, as shown in the embodiment of FIG. 6, each first reply region 601c, 602c, 603c, 604c is marked with an “X”, whereas each second reply region 601d, 602d, 603d, 604d is marked with a “check” (“✓”) sign. Alternatively, or additionally, each first reply region 601c, 602c, 603c, 604c may have a first color, such as red, whereas each second reply region 601d, 602d, 603d, 604d may have a second color contrasting with the first color, the second color e.g. being green.

A first reply region 601c, 602c, 603c, 604c may be selected to indicate that the associated future event as indicated in the corresponding event description region 601a, 602a, 603a, 604a and support region 601b, 602b, 603b, 604b, respectively, is predicted by the user not to take place. By contrast, a second reply region 601d, 602d, 603d, 604d may be selected by the user to indicate that the associated future event as indicated in the corresponding event description region 601a, 602a, 603a, 604a and support region 601b, 602b, 603b, 604b, respectively, is predicted by the user to take place.

For a particular event region 601, 602, 603, 604, a user may select either the first reply region 601c, 602c, 603c, 604c, or the second reply region 601d, 602d, 603d, 604d, respectively, through control of the input device 202 (FIG. 2). In some embodiments, the input device 202 may comprise a computer mouse to control a cursor on the display 204 to position it in a region of choice, and thereafter clicking on a mouse button to confirm the selection. In some embodiments, the input device 202 may comprise a touch screen, where an object such as a human finger or other body part, or a pencil may be used to touch the screen at a selected region, thereby confirming the selection.

After making the selection, the selected first reply region 601c, 602c, 603c, 604c, or the selected second reply region 601d, 602d, 603d, 604d, respectively, for a particular event is highlighted in an appropriate way. In some embodiments, initially, when no selection has been made yet, the first reply regions 601c, 602c, 603c, 604c and second reply regions 601d, 602d, 603d, 604d are shaded (displaying no, or a bleak color). When a selection has been made for an event in a particular event region 601, 602, 603, 604, the selected first reply region 601c, 602c, 603c, 604c, or the selected second reply region 601d, 602d, 603d, 604d, respectively, may turn to show a bright color, whereas the adjacent other reply region remains uncolored, or a bleak color.

In some embodiments, when a selection has been made for an event in a particular event region 601, 602, 603, 604, the selected first reply region 601c, 602c, 603c, 604c, or the selected second reply region 601d, 602d, 603d, 604d, respectively, may be enlarged to cover the previous total area of the first reply region 601c, 602c, 603c, 604c and the second reply region 601d, 602d, 603d, 604d, respectively. For example, FIG. 7 illustrates such embodiment in which choices have been made for the event regions 601 (indicating the event associated with event region 601 predicted by the user not to take place) and 603 (indicating the event associated with event region 603 predicted by the user to take place).

When the user has confirmed a selection, a choice data item 420, 422, 424, . . . (FIG. 4) is generated in association with the user ID 430 (FIG. 4) and the particular event, e.g. as identified by its event data item 410 (FIG. 4). At the server 102, 300 or at a storage under control of the server 102, 300, each choice data item 420, 422, 424, . . . generated by the user is received (FIG. 5, 504) and stored in association with the corresponding event data item 410 and the user ID 430 (FIG. 5, 506).

In some embodiments, when a number of event regions 601, 602, 603, 604 are shown on the display 204, a user is allowed to indicate his/her prediction only for a lower number of events then there are event regions 601, 602, 603, 604. Hereby, the user is free to choose to make a prediction for a predetermined maximum number of events, and free to choose not to make a prediction for one or more other ones (FIG. 5, 507). Thus, the user may choose to make predictions for events of a category he/she is (or believes to be) more comfortable or familiar with than with other ones. In some embodiments, the number of event-related data sets 402, 404, 406 used to build associated event regions 601, 602, 603, 604 is at least twice as high as the number of choice data items 420, 422, 424, . . . to be received from the user. As illustrated in FIG. 7, if a maximum of two selections out of four are allowed to be made, after having made the second (last) selection, the remaining first reply regions 602c, 604c, and the remaining second reply regions 602d, 604d cannot be selected any more, as illustrated in FIG. 7.

The likelihood of the event occurring in future may vary, but in principle the event may or may not occur so that for a particular event, mere guessing of the occurrence of the future event results in a 50% chance of making the wrong or right selection.

For the future events as shown in the event regions 610, 602, 603, 604, choice data items 420, 422, 424, . . . can be generated by the user only during a particular time period which ends at a specified time (which may also be referred to as a closing time), when the event has not taken place yet. The closing time may be a particular point in time at a day, where the local time of the user may or may not be taken into account. Once the user has transmitted his/her predictions in the form of choice data items 420, 422, 424, . . . received and stored by the server 102, 300, the user will have to wait at least until after said closing time before he/she may conclude whether or not his/her predictions were correct or not. In some embodiments, the user will have to wait at least until after said closing time before he/she may make new predictions for new future events.

At least some time after said closing time, the future events related to the event regions 601, 602, 603, 604 will take place (FIG. 5, 508), thus becoming past events, and then it will be known whether the events have taken place or not, in other words: which value the status data item 412 (FIG. 4) for each one of the past events should take. The status data items 412 are updated accordingly (FIG. 5, 510).

Then, for each choice data item 420, 422, 424, . . . input by the user during a predetermined time period, or for a predetermined number of past events, the choice data item 420, 422, 424, . . . is compared to the status data item 412 for the corresponding past event (FIG. 5, 514), until the last choice data item 420, 422, 424, . . . has been compared to the status data item 412 for the corresponding past event (FIG. 5, 512).

If the choice data items 420, 422, 424, . . . input by the user over a predetermined time period are, at a specific time, compared to the corresponding status data items 412, the predetermined time period precedes said specific time, and has a predetermined relationship with said specific time. For example, said specific time is a predetermined time of day. Then, in some embodiments, said predetermined time period may be a fixed length time interval, and extend up to and including the day immediately preceding the day having said specific time.

If the choice data items 420, 422, 424, . . . input by the user relate to a predetermined number of past events, and are, at a specific time, compared to the corresponding status data items 412, the past events for which a prediction was made by the user may precede said specific time and have a predetermined relationship with said specific time. In some embodiments, the number of past events for which a prediction was made by the user relate to the youngest past events preceding said specific time. Said predetermined number of past events may e.g. be twenty-two, whereby the user may have made, as a minimum, not a single correct prediction, and as a maximum, twenty-two correct predictions.

It is noted that a user need not participate in the prediction game every time that new event data items 410 are generated. Reasons for not participating may be lack of time, inability to participate, or any other reason. When the above comparison between choice data items 420, 422, 424, . . . is made over a predetermined period of time, the number of predictions input by the user over said predetermined period of time may drop as a result of non-participation, and consequently, the number of correct predictions may also drop as a result of this non-participation. When, however, the above comparison between choice data items 420, 422, 424, . . . is made for past events for which actually a prediction was made by the user, the number of predictions input by the user will not change as a result of non-participation, and consequently, the number of correct predictions will also not change as a result of this non-participation.

If, in these comparisons, the choice data item 420, 422, 424, . . . corresponds to the status data item, count data 442 (FIG. 4) associated with the user ID 430 is incremented (FIG. 5, 516). In the example explained with reference to FIGS. 6 and 7, the count data 442 may not be incremented when the user has made two wrong predictions, the count data 442 may be incremented once when the user has made one right prediction and one wrong prediction, and the count data 442 may be incremented twice when the user has made two rights predictions. Count data 442 may be shown to the user through the display 204.

In some embodiments, the count data 442 for correct predictions may (also) be stored as a level and shown on the display 204. In an embodiment, as illustrated in FIG. 7, an indicator shaped as an arrow 700 indicates a number of correct predictions (here: ten) within a set of 22 predictions made by the user, and listed in prediction number region 702 displayed as a scale. Other types of images to provide the same information to a user through the display 204 may include a tachometer-type display having an indicator pointing at a number listed along a scale.

When the level is used locally, i.e. only for ranking among a particular group of users among the total number of users, count data 442 may be stored as local level data 444 and shown on the display 204 in a region 610, whereas when the level is used for ranking among the total number of users, count data 442 may be stored as global level data 446 and shown on the display 204 in a region 612.

In some embodiments, global level data 446 reflect the number of predictions made by the user from a particular point in time (e.g. the time the user started to participate in the prediction game). When the global level data 446 reach or exceed a predetermined level, e.g. 100, the user may participate in another (global) version of the prediction game, playing against other players having also reached or exceeded said predetermined global level. In some embodiments, when a predetermined level of count data 442 is reached, the global level data 446 may be incremented with a bonus number.

The user may retrieve event regions for past events, to inspect his/her own prediction results over a past period of time. For this purpose, a display view of, or similar to FIG. 7 may be used. To provide easy and powerful feedback to the user to indicate whether or not the user made a correct or an incorrect prediction, two different colors may be used for coloring a respective event description region 601a, 602a, 603a, 604a and a respective one of the first reply regions 601c, 602c, 603c, 604c or the second reply regions 601d, 602d, 603d, 604d in the event regions 601, 602, 603, 604. If a first color, e.g. green, is used to indicate that the past prediction was correct, an event description region 601a, 602a, 603a, 604a stating a correct prediction may be provided with the first color. If a second color different from the first color, e.g. red, is used to indicate that the past prediction was incorrect, an event description region 601a, 602a, 603a, 604a stating an incorrect prediction may be provided with the second color. Now, for the first reply regions 601c, 602c, 603c, 604c, indicating that the user predicted the event to take place, the first color is selected, whereas for the second reply regions 601d, 602d, 603d, 604d, the second color is selected.

Referring to FIG. 7, supposing that the event associated with event region 601 did take place, the event description region 601a will be colored the first color, such as green. However, the first reply region 601c for the event region 601 is colored the second color, such as red, following the prediction of the user. The user, seeing at a glance two different colors in the same event region 601, immediately and effortlessly understands that for this event his/her count was not incremented, since he/she made an incorrect prediction. On the other hand, supposing that the event associated with event region 603 also did take place, the event description region 603a will be colored the first color, such as green. Likewise, the second reply region 603d for the event region 603 is also colored the first color, such as green, following the prediction of the user. The user, here seeing at a glance the event description region 603a and the second reply region 603d in the same color, will immediately and effortlessly understand that for this event his/her count was incremented, since he/she made a correct prediction.

The remaining event regions 602, 604 may have event description regions 602a, 604a, first reply regions 602c, 604c, and second reply regions 602d, 604d which may not carry any particular indication or color, or may even not be present, which in particular may be the case for the reply regions.

The prediction game as described above may further have a training mode in which event regions 601, 602, 603, 604 for past events may be retrieved and choice data items for the corresponding events may be generated by the user as described above in relation with FIGS. 5 and 6. Correct and incorrect predictions may be checked by thereafter in a user interface explained in conjunction with FIG. 7.

As part of the prediction game, the user is challenged to participate on a regular basis. In an embodiment, the user may play the prediction game once a day. Referring to the example above, every day the count may be incremented twice at maximum. When a count (score of correct predictions) over a preceding time period of 11 days is considered, the count may have been incremented twenty-two times at maximum in this time period. For each day that a user does not participate in the prediction game during the immediately preceding time period, the count will be decremented twice. So, the user, in order not to lose count value, is challenged to participate every day during extended periods of time. This is easily done, and may take less than a minute per day. On the other hand, when the user misses one day out of a sequence of days, he/she will still retain most of the count previously established, thereby stimulating his/her continued participation in the game.

Participants may be stimulated to continue to participate further by awarding prizes when a count or local level or global level has reached a certain level. This may be done in a local competition only taking into account counts or local levels of users of a particular group amongst the total number of participants, or in a global competition taking into account counts or global levels of all of the participants.

As explained above, in a prediction game method, system en server, data are transmitted and received through a network between a server and a user terminal. Computer software is provided to store a plurality of event data items and corresponding status data items, indicating whether the corresponding event has taken place or not, each data item associated with an event. A plurality of event data items for future events are transmitted to a user identified by a user identification. At least one choice data item transmitted by the user is received, each choice data item relating to a corresponding event data item, and indicating whether the user predicts the future event indicated by the corresponding event data item to take place or not. Received choice data item are stored in association with the corresponding event data item and the user identification. When an event becomes a past event, the corresponding status data item is updated. Then, for each user, the stored choice data items are compared with the corresponding status data items of past events. If the stored choice data item corresponds to the status data item, a count associated with the user identification is incremented. The count is stored in association with the user identification, and the count is transmitted to the user.

As further explained above, in a computer-implemented method of controlling data input on a user terminal having a display in a prediction game, a plurality of event regions are displayed on the display. Each event region has an event description region configured to display a text indicating a future event, and a first reply region and a second reply region. In one of the event regions, a user input indicating one of the first and second reply regions is detected. Then, in one of the event regions, at least said one of the first and second reply regions is provided with a color different from a color of the other one of the first and second reply regions. Further, the method provides for displaying a plurality of event regions on the display, where each event region has an event description region configured to display a text indicating a past event, and a reply region for displaying a user selection of a prediction of the event to happen or not. For each event region, if the past event indicated in the event region did happen, the event description region is provided with a first color. If the past event indicated in the event region did not happen, the event description region is provided with a second color different from the first color. If the reply region displays a user selection of a prediction of the event to happen, the event description region is provided with the first color. If the reply region displays a user selection of a prediction of the event not to happen, the event description region is provided with the second color.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The term “data item” relates to computer data which together represent coded information. For the purpose of the present invention, the term may be deemed equivalent with the term “information”.

The mere fact that certain measures are recited in mutually different dependent claims does not indicate that a combination of these measures cannot be used to advantage.

A single processor or other unit may fulfill the functions of several items recited in the claims.

The terms computer software, program, software application, and the like as used herein, are defined as a set of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

A computer program may be stored and/or distributed on a suitable medium, such as an optical storage medium or a solid-state medium supplied together with or as part of other hardware, but also be distributed in other forms, such as via the Internet or other wired or wireless telecommunication systems.

1. A method for receiving and transmitting data between a server and a user terminal, through a network in a prediction game, the method comprising the steps to:
store at the server a plurality of event data items and corresponding status data items each associated with an event, wherein the status data item indicates whether the corresponding event has taken place or not, and is unavailable when the event is a future event, and is available when the event is a past event;
transmit from the server to the user terminal at least one event data item for a future event to a user identified by a user identification;
receive at the server from the user terminal at least one choice data item transmitted by the user identified by the user identification, each choice data item relating to a corresponding event data item, and indicating whether the user predicts the future event indicated by the corresponding event data item to take place or not;
store at the server each received choice data item in association with the corresponding event data item and the user identification;
update, for each past event, the corresponding status data item;
compare at the server, for each user identification, the stored choice data items with the corresponding status data items of past events and, if the stored choice data item corresponds to the status data item, increment a count associated with the user identification;
store at the server the count in association with the user identification; and
transmit the count from the server to the user terminal.

2. The method of claim 1, wherein the step to transmit at least one event data item comprises transmitting a plurality of event data items.

3. The method of claim 2, wherein the step to receive at least one choice data item comprises receiving a number of choice data items which is lower than the number of transmitted event data items.

4. The method of claim 2, wherein the number of event data items transmitted to the user is X, where X=2, 4, 6, 8, . . . , and the number of choice data items received from the user is Y, wherein 0<Y≦X/2.

5. The method of claim 4, wherein the number of event data items transmitted is 4, and the number of choice data items received is 2.

6. The method of claim 1, wherein the step to compare the stored choice data items with the corresponding status data items is performed for the stored choice data items and corresponding status data items relating to past events in a predetermined time period.

7. The method of claim 1, wherein the step to compare the stored choice data items with the corresponding status data items is performed for the stored choice data items and corresponding status data items relating to past events for which a prediction was made by the user.

8. The method of claim 7, wherein the step to compare the stored choice data items with the corresponding status data items is performed for the stored choice data items and corresponding status data items relating to a predetermined number of past events for which a prediction was made by the user.

9. The method of claim 6, wherein the step to compare the stored choice data items with the corresponding status data items is performed at a specific time, and wherein said predetermined time period precedes said specific time and has a predetermined relationship with said specific time.

10. The method of claim 9, wherein said specific time is a predetermined time of day.

11. The method of claim 10, wherein the predetermined time period extends up to and including the day immediately preceding the day having the specific time.

12. The method of claim 7, wherein the step to compare the stored choice data items with the corresponding status data items is performed at a specific time, and wherein the past events for which a prediction was made by the user precede said specific time and have a predetermined relationship with said specific time.

13. The method of claim 12, wherein the number of past events for which a prediction was made by the user relate to the youngest past events preceding the specific time.

14. The method of claim 6, wherein said predetermined time period is Z days, where Z>5.

15. The method of claim 1, further comprising the step to transmit from the server to the user terminal at least one support data item along with the corresponding event data item, wherein the at least one support data item is selected from a group of support data items comprising a still picture, a moving picture, a graphical item, characters, and text.

16. The method of claim 1, further comprising, for a past event, the step to transmit from the server to the user terminal at least one event data item associated with the past event, together with an indicator of the associated status data item and associated choice data item for the user to check a similarity or dissimilarity between the status data item and the choice data item.

17. A prediction game system, comprising a server, a user terminal, and a network configured for receiving and transmitting data between the server and the user terminal, the system comprising computer software on a non-transitory computer readable medium, the computer software comprising computer instructions configured to enable the system to:
store at the server a plurality of event data items and corresponding status data items each associated with an event, wherein the status data item indicates whether the corresponding event has taken place or not, and is unavailable when the event is a future event, and is available when the event is a past event;
transmit from the server to the user terminal at least one event data item for a future event to a user identified by a user identification;
receive at the server from the user terminal at least one choice data item transmitted by the user identified by the user identification, each choice data item relating to a corresponding event data item, and indicating whether the user predicts the future event indicated by the corresponding event data item to take place or not;
store at the server each received choice data item in association with the corresponding event data item and the user identification;
update, for each past event, the corresponding status data item;
compare at the server, for each user identification, the stored choice data items with the corresponding status data items of past events and, if the stored choice data item corresponds to the status data item, increment a count associated with the user identification;
store at the server the count in association with the user identification; and
transmit the count from the server to the user terminal.

18. A prediction game server configured for transmitting and receiving data to and from a user terminal through a network, the server comprising computer software on a non-transitory computer readable medium, the computer software comprising computer instructions configured to enable the server to:
store a plurality of event data items and corresponding status data items each associated with an event, wherein the status data item indicates whether the corresponding event has taken place or not, and is unavailable when the event is a future event, and is available when the event is a past event;
transmit to the user terminal at least one event data item for a future event to a user identified by a user identification;
receive from the user terminal at least one choice data item transmitted by the user identified by the user identification, each choice data item relating to a corresponding event data item, and indicating whether the user predicts the future event indicated by the corresponding event data item to take place or not;
store each received choice data item in association with the corresponding event data item and the user identification;
update, for each past event, the corresponding status data item;
compare, for each user identification, the stored choice data items with the corresponding status data items of past events and, if the stored choice data item corresponds to the status data item, increment a count associated with the user identification;
store the count in association with the user identification; and
transmit the count to the user terminal.

19. (canceled)
